(19) United States
(12) Patent Application Publication
(10) Pub. No.: US 2020/0260651 A1
(43) Pub. Date: Aug. 20, 2020

(54) METHOD FOR CULTIVATING PLANT SEEDLING BY ARTIFICIAL LIGHT

(71) Applicant: SHOWA DENKO K.K., Tokyo (JP)

(72) Inventors: Noriko OHTAKE, Tokyo (JP); Akiko SHINODA, Tokyo (JP); Takashi WATANABE, Tokyo (JP); Yuki YAMAGUCHI, Ishioka-shi, Ibaraki (JP); Akimasa NAKANO, Tokyo (JP)

(73) Assignee: SHOWA DENKO K.K., Tokyo (JP)

(21) Appl. No.: 16/347,354

(22) PCT Filed: Feb. 2, 2018
(86) PCT No.: PCT/JP2018/003588

§ 371 Date: May 3, 2019

(30) Foreign Application Priority Data
Feb. 2, 2017 (JP) 2017-017663

(51) Int. Cl. A01G 7/04; A01G 22/05; H05B 47/16

(52) U.S. Cl. CPC A01G 7/045; H05B 47/16; A01G 22/05

(57) ABSTRACT

The present invention provides a method for cultivating a plant seedling, which can cultivate a seedling causing no spindly growth, having a thick stem, and being favorably grown even after planting. The method for cultivating a plant seedling of the present invention is a method for cultivating a plant seedling by irradiation of a plant seedling with artificial light for promotion of growth, comprising continuously irradiating the plant seedling with blue illumination light for period (A), wherein 30% or more and less than 80% of the time taken for period (A) for continuously irradiating the plant seedling with blue illumination light corresponds to period (A-1) for continuously irradiating the plant seedling with blue illumination light and red illumination light.

### TECHNICAL FIELD

The present invention relates to a method for cultivating a plant seedling, specifically relates to a method for cultivating a plant seedling, including irradiating a plant seedling with artificial light.

### DESCRIPTION OF THE RELATED ART

### Background Art

There has been conventionally introduced into plant cultivation a technique where a plant seedling is irradiated with artificial light for promotion of raising seedling. A plant seedling is easily affected by the environment and therefore is advantageously cultivated in closed equipment using artificial light. In addition, promotion of growth can decrease the cultivation period, resulting in an increase in the number of harvests at the same place. A large seedling enables the cultivation period after transplanting into a farm field to be decreased, resulting in an increase in the crop yield in the entire farm field.

Many plant cultivation methods including irradiating a plant with artificial light have been conventionally known (see, for example, Patent documents 1 to 3).

Patent document 1 proposes a plant cultivation method including irradiating a plant which tends to suffer from injuries induced by continuous light with continuous light from a main light source for 24 hours while further simultaneously continuously irradiating the plant with light from a blue light source as an auxiliary light source for 1 to 23 hours, and thereafter not irradiating the plant with light from the auxiliary light source.

Patent document 2 proposes a method of controlling elongation of a seedling, the method including irradiating a seedling with light plentifully including green light and including at least one of blue light and red light for photosynthesis in a required amount, for a period where suppression after sprouting is required, to suppress elongation of hypocotyl.

Patent document 3 proposes a plant cultivation method including a step of irradiating a plant with red illumination light, and a step of irradiating the plant with blue illumination light, wherein these two steps are alternately performed continuously and the respective steps are performed for 3 hours or more and less than 48 hours.

### CITATION LIST

### Patent Literature

[Patent Literature 1] JP2015-167544A

[Patent Literature 2] JP2010-104260A

[Patent Literature 3] WO2013/021952

### SUMMARY OF INVENTION

### Technical Problem

According to findings about plant seedling cultivation by irradiation with artificial light, a technique using a fluorescent lamp has been put in practical use.

In recent years, however, a light-emitting diode (LED) high in electric power saving has been used.

LED not only achieves energy saving, but also can highly effectively and minimally radiate light at an aimed wavelength depending on the light response of a plant, and therefore LED provides a technique which enables a more effective light irradiation method.

For example, single irradiation with red light by use of LED, however, has been reported to cause a seedling to suffer spindly growth, resulting in the occurrence of leaf scorch. In addition, single irradiation with blue light tends to cause growth faults or suppress differentiation of a floral bud. On the other hand, simultaneous irradiation with red light and blue light suppresses spindly growth, and allows the quality comparable with that of a seedling cultivated by using a fluorescent lamp to be achieved. In addition, alternate irradiation with red light and blue light promotes favorable growth of a plant body planted, but tends to cause a plant seedling to suffer spindly growth.

When comparing qualities of a plant seedling cultivated by using a fluorescent lamp and a plant seedling cultivated by simultaneous irradiation with red light and blue light with a plant seedling cultivated under sun light, the former are each a plant seedling including a larger amount of anthocyanin and thus providing a red leaf, and thus it have been demanded that they are improved in terms of growth and appearance.

An purpose of the present invention is to provide a method for cultivating a plant seedling wherein even in the case of raising seedling by irradiation with artificial light, the method can suppress spindly growth, grow a stable plant seedling having a green leaf small in the amount of anthocyanin, and grow a high-quality plant seedling that is to be favorably grown even after planting.

### Solution to Problem

The present inventors have made intensive studies about a method for cultivating a plant seedling by irradiation with artificial light for promotion of growth, and as a result, have found that the problem can be solved by irradiation with blue illumination light and red illumination light according to a specified method, thereby leading to completion of the present invention.

That is, the present invention includes the following [1] to [20].

[1] A method for cultivating a plant seedling by irradiation of a plant seedling with artificial light for promotion of growth, the method comprising

continuously irradiating the plant seedling with blue illumination light for period (A), wherein 30% or more and less than 80% of a time taken for period (A) for continuously irradiating the plant seedling with blue illumination light corresponds to period (A-1) for continuously irradiating the plant seedling with blue illumination light and red illumination light.

[2] The method for cultivating a plant seedling according to [1], wherein a time taken for one period (A-1) for continuously irradiating the plant seedling with blue illumination light and red illumination light is 1 to 20 hours.

[3] The method for cultivating a plant seedling according to [1] or [2], comprising not irradiating the plant seedling with any light for period (B).

[4] The method for cultivating a plant seedling according to [3], wherein a time taken for one period (B) for not irradiating the plant seedling with any light is 1 to 12 hours.

[5] The method for cultivating a plant seedling according to [3] or [4], wherein a time taken for period (B) for not irradiating the plant seedling with any light is 4 to 50% relative to 100% of the time taken for period (A) for continuously irradiating the plant seedling with blue illumination light.

[6] The method for cultivating a plant seedling according to any one of [3] to [5], wherein continuously irradiating the plant seedling with blue illumination light for period (A) and not irradiating the plant seedling with any light for period (B) are alternately repeated.

[7] The method for cultivating a plant seedling according to any one of [3] to [6], comprising continuously irradiating the plant seedling with only red illumination light for period (C) between period (A) for continuously irradiating the plant seedling with blue illumination light and period (B) for not irradiating the plant seedling with any light wherein a time taken for period (C) is more than 0 hours and 5 hours or less.

[8] The method for cultivating a plant seedling according to any one of [3] to [6], not comprising continuously irradiating the plant seedling with only red illumination light for period (C).

[9] The method for cultivating a plant seedling according to any one of [3] to [8], wherein the time taken for one period (A) for continuously irradiating the plant seedling with blue illumination light is 2 to 24 hours.

[10] The method for cultivating a plant seedling according to any one of [1] to [9], wherein the blue illumination light has a wavelength range from 400 to 515 nm and a center wavelength of 430 to 470 nm.

[11] The method for cultivating a plant seedling according to any one of [1] to [10], wherein the red illumination light has a wavelength range from 570 to 730 nm and a center wavelength of 640 to 680 nm.

[12] The method for cultivating a plant seedling according to any one of [1] to [11], wherein an amount of the blue illumination light is 40 to 200 μmol/(m² s) in terms of a photosynthetic photon flux density on a plant cultivation surface.

[13] The method for cultivating a plant seedling according to any one of [1] to [12], wherein an amount of the red illumination light is 40 to 500 μmol/(m² s) in terms of a photosynthetic photon flux density on a plant cultivation surface.

[14] The method for cultivating a plant seedling according to any one of [1] to [13], wherein, during period (A-1) for continuously irradiating the plant seedling with blue illumination light and red illumination light, a photosynthetic photon flux density of the red illumination light is 100 to 1000% relative to a photosynthetic photon flux density of the blue irradiation light on a plant cultivation surface.

[15] The method for cultivating a plant seedling according to any one of [1] to [14], wherein a humidity in cultivation is 39 to 90%.

[16] The method for cultivating a plant seedling according to any one of [1] to [15], wherein a temperature in cultivation is 16 to 28° C.

[17] The method for cultivating a plant seedling according to any one of [1] to [16], wherein the plant seedling is a fruit vegetable seedling.

[18] The method for cultivating a plant seedling according to any one of [1] to [16], wherein the plant seedling is a nightshade plant seedling.

[19] The method for cultivating a plant seedling according to any one of [1] to [16], wherein the plant seedling is a tomato seedling.

[20] A method for cultivating a plant, comprising planting in a farm field a plant seedling cultivated by the method for cultivating a plant seedling according to any one of [1] to [19] and cultivating the plant seedling by natural light.

### Advantageous Effects of Invention

The present invention provides a method for cultivating a plant seedling which can cultivate a plant seedling causing no spindly growth, having a green leaf small in the amount of anthocyanin, and being favorably grown even after planting.

### DESCRIPTION OF EMBODIMENTS

The method for cultivating a plant seedling of the present invention is a method for cultivating a plant seedling by irradiation of a plant seedling with artificial light for promotion of growth, the method including continuously irradiating the plant seedling with blue illumination light for period (A), wherein 30% or more and less than 80% of the time taken for period (A) for continuously irradiating the plant seedling with blue illumination light corresponds to period (A-1) for continuously irradiating the plant seedling with blue illumination light and red illumination light.

Hereinafter, suitable embodiments for carrying out the present invention will be described. Herein, any embodiment described below is illustrative as one example of representative embodiments of the present invention, and the scope of the present invention is not to be thereby narrowly construed.

In the present invention, continuously irradiating the plant seedling with illumination light is carried out. “Continuously irradiating” usually means continuously irradiating the plant seedling with illumination light, but there may be a time for which the plant seedling is not irradiated with any illumination light as long as it is a short time. Herein, the short time usually means 30 minutes or less, preferably 5 minutes or less, more preferably 1 minute or less.

The cultivation method of the present invention includes continuously irradiating a plant seedling with blue illumination light for period (A).

The blue illumination light in the present invention is usually illumination light including blue light having a wavelength range from 400 to 515 nm. The blue illumination light is required to include the blue light. The blue illumination light may include light having a wavelength range different from that of the blue light, but does not substantially include red light described below. The blue illumination light particularly preferably includes only the blue light.

The blue illumination light preferably has a center wavelength of 430 to 470 nm because of being highly efficient for a photosynthesis reaction and being highly effective particularly for morphology control such as suppression of spindly growth.

The blue illumination light is optimally blue light having a center wavelength of 440 to 460 nm in view of increasing the effect of the present invention.

In the cultivation method of the present invention, 30% or more and less than 80% of the time taken for period (A) for continuously irradiating the plant seedling with blue illumination light corresponds to period (A-1) for continuously irradiating the plant seedling with blue illumination light and red illumination light.

The red illumination light in the present invention is usually illumination light including red light having a wavelength range from 570 to 730 nm. The red illumination light is required to include the red light. The red illumination light may include light having a wavelength range different from that of the red light, but does not substantially include the above-mentioned blue light. The red illumination light particularly preferably includes only the red light.

The red illumination light preferably has a center wavelength of 640 to 680 nm because of being highly efficient for a photosynthesis reaction and being highly effective particularly for an enhancement in growth speed.

In period (A-1), it is preferable that the red illumination light and the blue illumination light include only the red light and only the blue light respectively.

A conventionally known artificial light source can be used for the light source of each of the blue illumination light and the red illumination light, and an optical semiconductor element such as a light-emitting diode (LED) or a laser diode (LD) is preferably used because of being easy in selection of wavelength and radiating light high in the proportion of energy of light in an effective wavelength range. A light source may also be adopted in which a blue LED and a red phosphor are combined. When electroluminescence (EL) is used, such EL may be organic EL or may be inorganic EL. LED is most desirably adopted in terms of luminescent efficiency. In particular, the light source of the red illumination light is optimally a LED in which an AlGaInP light-emitting layer, which is high in luminescent efficiency, is used. In addition, the light source of the blue illumination light is optimally a LED in which an InGaN light-emitting layer, which is high in luminescent efficiency, is used.

In the cultivation method of the present invention, 30% or more and less than 80% of the time taken for period (A) for continuously irradiating the plant seedling with blue illumination light corresponds to period (A-1) for continuously irradiating the plant seedling with blue illumination light and red illumination light, as described above, and 40 to 65% of the time taken for period (A) preferably corresponds to period (A-1). If the length of period (A-1) occupies more than 80%, a plant seedling is poorly grown, and if the length occupies less than 30%, a plant seedling tends to suffer spindly growth. Therefore, the above range is preferable.

Herein, examples of a term of period (A) other than period (A-1) for continuously irradiating the plant seedling with blue illumination light and red illumination light include period (A-2) for continuously irradiating the plant seedling with blue illumination light and not irradiating the plant seedling with any red illumination light. In the present invention, the time taken for period (A) is preferably matched with the total of the time taken for period (A-1) and the time taken for period (A-2). That is, 20 to 70%, preferably 35 to 60% of the time taken for period (A) for continuously irradiating the plant seedling with blue illumination light corresponds to period (A-2) for continuously irradiating the plant seedling with blue illumination light and not irradiating the plant seedling with any red illumination light. Herein, period (A-2) is preferably period (A′-2) for continuously irradiating the plant seedling with only blue illumination light.

In the present invention, the time taken for one period (A-1) is preferably 1 to 20 hours, more preferably 6 to 16 hours. Such ranges are preferable because the morphology of a plant seedling is favorable.

In the present invention, the time taken for one period (A-2) is preferably 1 to 20 hours, more preferably 4 to 16 hours. Such ranges are preferable because the morphology of a plant seedling is favorable.

The cultivation method of the present invention may include not irradiating the plant seedling with any light for period (B) (dark period). Depending on the type, some plant seedling suffers from injuries induced by continuous light if cultivated with constant irradiation with light. In the case of such a plant seedling, a dark period is preferably provided.

When the cultivation method of the present invention includes not irradiating the plant seedling with any light for period (B), the time taken for one period (B) is preferably 1 to 12 hours, more preferably 2 to 6 hours.

When period (B) is provided in the cultivation method of the present invention, it is preferable that continuously irradiating the plant seedling with blue illumination light for period (A) and not irradiating the plant seedling with any light for period (B) be alternately repeated. In this case, period (A) may be first started, or period (B) may be first started. The cultivation method of the present invention may be terminated at period (A), or may be terminated at period (B).

When the cultivation method of the present invention includes not irradiating the plant seedling with any light for period (B), the time taken for period (B) for not irradiating the plant seedling with any light is preferably 4 to 50%, more preferably 4 to 25% relative to 100% of the time taken for period (A) for continuously irradiating the plant seedling with blue illumination light. Herein, when period (A) and period (B) are alternately repeated in the cultivation method of the present invention, the times taken for each period (A) and each period (B) are preferably within the above ranges. In addition, the times taken for period (A) and period (B) are preferably within the above ranges also in the entire cultivation method of the present invention.

Herein, the time taken for each of one period (A), one period (A-1), one period (A-2), one period (B), and the like means a time taken for one of each of such periods. In other words, when period (A-2), period (A-1) and period (B) are repeated, each of such periods is taken plural times in the cultivation method of the present invention, and the time taken for each of the plural times of periods (A-2), (A-1) or (B) corresponds to a time taken for one period.

In the cultivation method of the present invention, one period (A) may include a plurality of periods (A-1) and/or a plurality of periods (A-2).

The cultivation method of the present invention may include only continuously irradiating the plant seedling with blue illumination light for period (A), and when period (B) is provided, the time taken for one period (A) is preferably 2 to 24 hours, more preferably 12 to 22 hours. Such ranges are preferable because the growth of a plant seedling is favorable.

When period (A) and period (B) are alternately repeated in the cultivation method of the present invention, the total time taken for one period (A) and one period (B) is preferably 3 to 36 hours, more preferably 14 to 28 hours.

The cultivation method of the present invention may include continuously irradiating the plant seedling with only red illumination light for period (C) between period (A) for continuously irradiating the plant seedling with blue illumination light and period (B) for not irradiating the plant seedling with any light. When period (C) is provided, the time taken for period (C) is preferably more than 0 hours and 5 hours or less, more preferably more than 0 hours and less than 3 hours, further preferably more than 0 hours and 1 hour or less in view of suppression of spindly growth of a plant seedling. Herein, the time corresponds to the time taken for one period (C). Alternatively, the cultivation method of the present invention preferably does not include continuously irradiating the plant seedling with only red illumination light for period (C), and also preferably includes substantially only period (A), or only period (A) and period (B), in view of suppression of spindly growth of a plant seedling.

In the present invention, the amount of the blue illumination light is preferably 40 to 200 μmol/(m² s), more preferably 80 to 180 μmol/(m² s), further preferably 100 to 160 μmol/(m² s) in terms of a photosynthetic photon flux density on a plant cultivation surface. The amount of the red illumination light is preferably 40 to 500 μmol/(m² s), more preferably 120 to 400 μmol/(m² s), further preferably 200 to 300 μmol/(m² s) in terms of a photosynthetic photon flux density on a plant cultivation surface. If such photosynthetic photon flux densities are less than the above ranges, growth of a plant seedling may be poor. If such photosynthetic photon flux densities are more than the above ranges, growth of a plant seedling is unlikely to change, resulting in wasting energy.

In period (A-1) for continuously irradiating the plant seedling with blue illumination light and red illumination light in the present invention, the photosynthetic photon flux density on a plant cultivation surface, of the red illumination light, is preferably 100 to 1000%, more preferably 100 to 500%, further preferably 100 to 350% of the photosynthetic photon flux density of the blue irradiation light. Such ranges are preferable because favorable photosynthesis occurs

Herein, the plant cultivation surface in the present invention means the upper surface of a culture medium filled into a support such as a pot or a cell tray for plant seedling cultivation, and the amount of light is measured with a sensor placed on the cultivation surface. Herein, when a plant seedling is cultivated by hydroponic cultivation, mist cultivation or the like without any culture medium such as a soil, a rock wool or a coconut husk, the plant cultivation surface means the top of a panel where a plant seedling is to be planted.

The cultivation method of the present invention promotes growth of a plant seedling. The plant seedling is not particularly limited as long as it is a seedling of plant, and examples include seedlings of the following plants.

Examples of the plant include leaf vegetables, fruit vegetables, root vegetables, fruit trees, cereals, moss, fern, foliage plants, and medical plants. The cultivation system of such plants is also not particularly limited, and may be hydroponic cultivation, soil cultivation, nutrient solution cultivation, solid culture medium cultivation, or the like.

Examples of the leaf vegetables include those belonging to the family Brassicaceae, such as potherb mustard, Japanese mustard spinach, karashimizuna, leaf mustard, Eutrema wasabi Maxim, watercress, Chinese cabbage, pickled greens, green pak choi, cabbage, cauliflower, broccoli, Brussels sprouts, arugula and pino green; those belonging to the family Compositae, such as lettuces, Boston lettuce, garland chrysanthemum, butterbur, Rororossa, red romaine and chicory; those belonging to the family Liliaceae, such as onion, garlic, shallot, Chinese chive and asparagus; those belonging to the family Apiaceae, such as parsley, Italian parsley, Japanese honeywort, celery, Japanese parsley and dill; those belonging to the family Labiatae, such as beefsteak plant, basil and rosemary; those belonging to the family Alliaceae, such as green onion; those belonging to the family Araliaceae, such as udo; and those belonging to the family Zingiberaceae, such as Japanese ginger.

Examples of the lettuces include head-forming lettuce, non-head-forming lettuce and semi-head-forming lettuce, and examples include leaf lettuce, frilly lettuce, romaine, green wave, green leaf, red leaf, Frill-Ice (registered trademark), River Green (registered trademark), frill leaf, fringe green, no-chip lettuce, moco lettuce, Korean lettuce and Chima/Korean lettuce.

Examples of the fruit vegetables include those belonging to the family Cucurbitaceae, such as melon, cucumber, squash, watermelon, crenshaw, oriental melon, bitter cucumber, courgette and winter melon; those belonging to the family Leguminosae, such as string bean, broad bean, pea and green soybean; those belonging to the family Solanaceae, such as tomato, eggplant, bell pepper, green pepper, chili pepper and paprika; those belonging to the family Rosaceae, such as strawberry; those belonging to the family Malvaceae, such as angled loofah; and those belonging to the family Poaceae, such as corn.

Examples of the root vegetables include those belonging to the family Brassicaceae, such as Japanese white radish, turnip and green horseradish; those belonging to the family Compositae, such as burdock; those belonging to the family Apiaceae, such as carrot; those belonging to the family Solanaceae, such as potato; those belonging to the family Araceae, such as Colocasia esculenta; those belonging to the family Convolvulaceae, such as sweet potato; those belonging to the family Dioscoreaceae, such as yam; those belonging to the family Zingiberaceae, such as Japanese ginger; those belonging to the family Nymphaeaceae, such as lotus root, and those belonging to the family Liliaceae, such as lily bulb.

Examples of the fruit trees include those belonging to the family Rosaceae, such as raspberry, blackberry, boysenberry, nankin cherry, pear and apple; those belonging to the family Ericaceae, such as blueberry and cranberry; those belonging to the family Grossulariaceae, such as currant and Ribes rubrum; those belonging to the family Anacardiaceae, such as mango; those belonging to the family Bromeliaceae, such as pineapple; those belonging to the family Moraceae, such as Ficus carica; those belonging to the family Vitaceae, such as grape; those belonging to the family Caprifoliaceae, such as blue honeysuckle; those belonging to the family Caricaceae, such as papaya; those belonging to the family Passifloraceae, such as passion fruit; those belonging to the family Cactaceae, such as dragon fruit; and those belonging to the family Maloideae, such as loquat.

Examples of the cereals include those belonging to the family Poaceae, such as foxtail millet, oat, barley, proso millet, wheat, rice, sticky rice, corn, adlay, Japanese millet and rye; those belonging to the family Amaranthaceae, such as grain amaranthus; and those belonging to the family Polygonaceae, such as buckwheat.

The moss includes mosses belonging to Bryopsida. Examples thereof include mosses belonging to the genus Racomitrium in Grimmiaceae in Grimmiales, so-called Racomitrium moss, such as Racomitrium japonicum.

Examples of the foliage plants include various foliage plants including ferns such as Adiantum raddianum, Pteris and selaginella, in addition to rose, miniature rose, gentian and Eustoma.

Examples of the medical plants include, in addition to Lithospermum Root, Swertia Herb and Ephedra Herb exclusively used for pharmaceutical products, Bupleurum Root, Glycyrrhiza, Japanese Angelica Root, Cnidium Rhizome and Panax ginseng which are not treated as pharmaceutical products as long as the efficacies and effects thereof as pharmaceutical products are not shown.

When the plant is, for example, a fruit vegetable, the plant seedling obtained by the cultivation method of the present invention can be grown and thereafter planted in a support such as a rock wool, a coconut husk, a urethane resin or a soil and cultivated in a farm field, though depending on the plant type. A plant seedling obtained by the cultivation method of the present invention causes no spindly growth, includes a green leaf small in the amount of anthocyanin and is favorably grown even after planting.

In the method for cultivating a plant seedling of the present invention, the temperature in cultivation may be a temperature at which cultivation of a plant seedling is commonly performed, and is not particularly limited and is preferably 16 to 28° C., more preferably 17 to 26° C., further preferably 18 to 25° C.

The humidity (relative humidity) in cultivation is preferably 39 to 90%, more preferably 50 to 80%, further preferably 65 to 75%.

In the cultivation method of the present invention, the temperature and the humidity are preferably within the above ranges. The reasons for this are because a seedling causing no spindly growth, having a thick stem and being promoted in growth can be provided, also because secondary raising seedling can be omitted when growth is sufficiently promoted, and because growth after planting is also favorable.

The carbon dioxide gas concentration in cultivation can be the concentration in the air, or can be a concentration obtained by addition of carbon dioxide gas. When carbon dioxide gas is added, the carbon dioxide gas concentration is not particularly limited, and the concentration in cultivation is preferably 400 to 1200 ppm, more preferably 600 to 1100 ppm, further preferably 700 to 1000 ppm in view of having positive effects on economic efficiency and growth.

In the cultivation method of the present invention, a fertilizer may also be used. Any fertilizer, including a commercially available fertilizer, can be used as the fertilizer depending on the plant type without any particular limitation. The active ingredient(s) of the fertilizer can be appropriately separately compounded and used.

The method for cultivating a plant seedling of the present invention can be applied to seedlings of various plants described above, and the plant seedling is preferably a fruit vegetable seedling, more preferably a nightshade plant seedling, further preferably a tomato seedling. Such plant seedlings provide a seedling causing no spindly growth, having a thick stem, being small in the amount of anthocyanin and exhibiting a deep green color. Therefore, a seedling to be favorably grown after planting is stably obtained, and such a plant is also highly demanded. Thus the method is thus preferable for such a plant.

The period for performing the method for cultivating a plant seedling of the present invention varies depending on the plant type and is not particularly limited, and when the plant is tomato, the period is usually within the range from 7 to 50 days, preferably 14 to 30 days, more preferably 18 to 24 days after seed leaf development. A plant seedling obtained by the raising seedling method of the present invention is planted, after secondary raising seedling if necessary.

When being tomato, the plant seedling obtained by the cultivation method of the present invention is preferably a plant seedling having a stem diameter of 4.5 mm or more and the number of leaves of 5 or more, more preferably a plant seedling having a stem diameter of 6 mm or more and the number of leaves of 6.5 or more.

The cultivation method of the present invention can be usually performed by use of a closed type raising seedling apparatus. The raising seedling apparatus for use in the present invention usually includes a light source of blue illumination light and a light source of red illumination light, and includes a control unit for controlling the amount (intensity) of light from the light source and the irradiation time. The raising seedling apparatus also usually includes equipment for providing a culture solution, water, a fertilizer, and the like to a plant seedling, and may include equipment for controlling the temperature, the humidity and the carbon dioxide concentration.

A plant seedling obtained by the cultivation method of the present invention may be subjected to secondary raising seedling, if necessary, and thereafter is usually planted. In the plant cultivation method of the present invention, a plant seedling cultivated by the method for cultivating a plant seedling of the present invention is planted in a farm field, and cultivated by natural light. A plant seedling cultivated by the method for cultivating a plant seedling of the present invention is a seedling causing no spindly growth, having a thick stem, being small in the amount of anthocyanin, and having a green leaf, and is thus favorably grown after planting.

### EXAMPLES

Hereinafter, the effect of the present invention will be illustrated in more details with reference to Examples. Herein, the present invention is not intended to be limited to the following Examples, and can be appropriately modified and carried out within the scope where the gist thereof is not changed.

An experiment was performed where a fruit vegetable seedling was raised by the cultivation method of the present invention. The experiment was performed in a closed type raising seedling apparatus. As an experiment sample, a tomato seed of ‘Momotaro York’ or ‘CFMomotaro York’ (Takii &Co., Ltd.) was used (abbreviation: Momotaro York is abbreviated as MOMO, and CF Momotaro York is abbreviated as CF). Each cell constituting a 72-cell tray (Cell Tray AP, produced by Tokan Kogyo Co., Ltd.) was filled with a culture soil (Seed Soil No. 1, produced by Sumitomo Forestry Co., Ltd.), and one grain of seed per cell was sown.

The culture soil after sowing was accommodated in a germination hastening device kept at 27° C., together with the cell tray, for 3 days, and was transferred to the raising seedling apparatus on day 3 after sowing, to start light irradiation (day 0 of cultivation). Thereafter, raising seedling was performed for 21 days or 18 days. A culture solution here used was obtained by dissolving 2.93 mL of High Tempo Cu (produced by Sumitomo Chemical Co., Ltd.) and 0.98 mL of High Tempo Ar (produced by Sumitomo Chemical Co., Ltd.) per liter, and had an electrical conductivity (EC) of 1.6 dS/m and a pH of 5.9. The content ratio of nitrogen (N), phosphoric acid (P) and potassium (K) satisfied N:P:K=5.9:1.1:2.4.

Irrigation was performed once a day for 10 minutes (from 08:30 to 08:40), and the cell tray was filled with the culture solution up to a level of about 30 mm from the bottom surface at the termination of irrigation.

The temperature and the humidity in cultivation were set to a temperature of 25° C. and a relative humidity of 70% in the case of condition A. The CO₂ concentration in the raising seedling apparatus was 1000 ppm. In the case of condition B, the temperature was set to 18° C. for the period from 0 to 8 o'clock and 25° C. for the period from 8 to 24 o'clock every day. The humidity was not controlled. Herein, the relative humidity actually measured in raising seedling was 39 to 60%. The CO₂ concentration in the raising seedling apparatus was 1000 ppm.

A light source used was a straight tube type LED lamp provided with illumination lamps of red illumination light and blue illumination light (RRB, item number: UL0005#01-0R, LED chip: 160 red chips+80 blue chips, wavelength: red: 640 to 680 nm, blue: 425 to 475 nm, center wavelength: red: 660 nm, blue: 450 nm, manufactured by Showa Denko K. K.). A dimmer equipped with a timer was used to independently modulate light of each color, thereby performing adjustment of the amount of irradiation light (abbreviation: red irradiation light is abbreviated as R, and blue irradiation light is abbreviated as B).

A light source for use in some Comparative Examples was a fluorescent lamp (Hitachi Hf fluorescent lamp, High lumic FHF32EX-N-K, three-wavelength daylight white fluorescent lamp, 32 W) (abbreviation: the illumination light by use of the fluorescent lamp is abbreviated as FL).

The photosynthetic photon flux density was measured using a light photon sensor (LI-190, LI-COR) and a light meter (LI-250, LI-COR).

In Example 3 and Comparative Example 3 described below, a seedling was taken out from the apparatus on day 21 of cultivation, and planted in a rock wool for plant cultivation “YASAIHANA-POT (75×75×75 mm)” (manufactured by Nippon Rockwool Corporation), to start cultivation in a secondary raising seedling room in a greenhouse. The irrigation was drip irrigation into a rock wool. On day 30 of cultivation, a slab having a length of 1000 mm “Grotop Expert” (manufactured by Grodan) was used to perform planting in a farm field so that the planting density was 3.75 roots/m² (day 0 of planting).

After the planting, the seedling was drawn by using “Tsurikko for tomato”, and a lateral bud was appropriately picked.

On day 30 of the planting, the number of flowers of each of first to third flower clusters, and the number of fruits and the amount of chlorophyll of each of the first and second flower clusters were measured.

The amount of chlorophyll was measured by using a chlorophyll meter (SPAD-502 Plus, manufactured by Konica Minolta, Inc.), and the amount was measured on the third leaf of the second flower cluster five times and the average value was defined as the measurement value.

The number of flowers and the number of fruits were visually counted.

The conditions of irradiation with artificial light were changed and the following Examples and Comparative Examples were performed. Specific cultivation conditions in each of Examples and Comparative Examples were set as follows.

### Example 1

Irradiation with 145 μmol m⁻² s⁻¹ of B was made for the period from 8 to 4 o'clock (the continuous irradiation time was 20 hours) and irradiation with 290 μmol m⁻² s⁻¹ of R was made for the period from 18 to 4 o'clock (the continuous irradiation time was 10 hours), per day during the period from day 0 to day 21 of cultivation where light irradiation was performed. No light irradiation was made for the period from 4 to 8 o'clock, and such a period was defined as a dark period (hereinafter, the dark period also being designated as D.). Herein, the temperature and the humidity in cultivation were according to condition A.

### Example 2

The same manner as in Example 1 was performed except that the cultivation period was changed from 21 days to 18 days.

### Example 3

The same manner as in Example 1 was performed except that the temperature and the humidity in cultivation were changed from condition A to condition B.

### Example 4

The same manner as in Example 1 was performed except that 145 μmol m⁻² s⁻² of B was changed to 80 μmol m² s⁻¹ of B and the temperature and the humidity in cultivation were changed from condition A to condition B.

### Example 5

Irradiation with 145 μmol m⁻² s⁻¹ of B was made for the period from 8 to 23 o'clock (the continuous irradiation time was 15 hours) and irradiation with 290 μmol m⁻² s⁻¹ of R was made for the period from 18 to 4 o'clock (the continuous irradiation time was 10 hours), per day during the period from day 0 to day 18 of cultivation where light irradiation was performed. No light irradiation was made for the period from 4 to 8 o'clock, and such a period was defined as a dark period (hereinafter, the dark period also being designated as D.). Herein, the temperature and the humidity in cultivation were according to condition B.

Herein, the period from 18 to 23 o'clock, where irradiation with both red illumination light and blue illumination light was made, corresponded to period (A-1), and the subsequent period from 23 to 4 o'clock, where irradiation with only red illumination light was made, corresponded to period (C) in Example 5.

### Comparative Example 1

Irradiation with 300 μmol m² s¹ of FL was made for the period from 8 to 24 o'clock (the continuous irradiation time was 16 hours) per day during the period from day 0 to day 21 of cultivation where light irradiation was performed. No light irradiation was made for the period from 0 to 8 o'clock, and such a period was defined as a dark period. Herein, the temperature and the humidity in cultivation were according to condition A.

### Comparative Example 2

The same manner as in Comparative Example 1 was performed except that the cultivation period was changed from 21 days to 18 days.

### Comparative Example 3

The same manner as in Comparative Example 1 was performed except that the temperature and the humidity in cultivation were changed from condition A to condition B.

### Comparative Example 4

Irradiation with 90 μmol m=² s⁻² of B and irradiation with 178 μmol m⁻² s⁻¹ of R were made for the period from 8 to 24 o'clock (the continuous irradiation time was 16 hours) per day during the period from day 0 to day 21 of cultivation where light irradiation was performed. No light irradiation was made for the period from 0 to 8 o'clock, and such a period was defined as a dark period dark period. Herein, the temperature and the humidity in cultivation were according to condition B.

### Example 6

Irradiation with 145 μmol m⁻² s⁻¹ of B was made for the period from 8 to 4 o'clock (the continuous irradiation time was 20 hours) and, during such a period, irradiation with 485 μmol s⁻¹ of R was made for the period from 22 to 4 o'clock (the continuous irradiation time was 6 hours), per day during the period from day 0 to day 21 of cultivation where light irradiation was performed. No light irradiation was made for the period from 4 to 8 o'clock, and such a period was defined as a dark period. Herein, the temperature and the humidity in cultivation were according to condition B.

### Example 7

The same manner as in Example 6 except that the period where irradiation with red irradiation light was made was changed from the period from 22 to 4 o'clock (the continuous irradiation time was 6 hours) to the period from 18 to 4 o'clock (the continuous irradiation time was 10 hours), and 485 μmol m⁻² s⁻¹ of R was changed to 290 μmol m⁻² s⁻¹ of R.

### Example 8

Irradiation with 161 μmol m⁻² s⁻¹ of B was made from the period from 8 to 2 o'clock (the continuous irradiation time was 18 hours), and, during such a period, irradiation with 322 μmol m⁻² s⁻¹ of R was made for the period from 17 to 2 o'clock (the continuous irradiation time was 9 hours), per day during the period from day 0 to day 21 of cultivation where light irradiation was performed. No light irradiation was made for the period from 2 to 8 o'clock, and such a period was defined as a dark period. Herein, the temperature and the humidity in cultivation were according to condition B.

### Comparative Example 5

The same manner as in Example 6 except that the period where irradiation with red irradiation light was made was changed from the period from 22 to 4 o'clock (the continuous irradiation time was 6 hours) to the period from 12 to 4 o'clock (the continuous irradiation time was 16 hours), and 485 μmol m⁻² s⁻¹ of R was changed to 182 μmol m⁻² s⁻¹ of R.

### Example 9

Irradiation with 145 μmol m² s⁻¹ of B was made for the period from 8 to 4 o'clock (the continuous irradiation time was 20 hours) and, during such a period, irradiation with 224 μmol m=⁻² s⁻¹ of R was made for the period from 15 to 4 o'clock (the continuous irradiation time was 13 hours), per day during the period from day 0 to day 21 of cultivation where light irradiation was performed. No light irradiation was made for the period from 4 to 8 o'clock, and such a period was defined as a dark period. Herein, the temperature and the humidity in cultivation were according to condition A.

### Comparative Example 6

Irradiation with 300 μmol m² s of FL was made for the period from 8 to 2 o'clock (the continuous irradiation time was 22 hours), per day during the period from day 0 to day 21 of cultivation where light irradiation was performed. No light irradiation was made for the period from 2 to 4 o'clock, and such a period was defined as a dark period. Herein, the temperature and the humidity in cultivation were according to condition A.

The results of Examples and Comparative Examples are shown in Tables 1 to 3.

Table 2 shows the results with respect to the resulting seedling evaluated according to the following criteria. In the following evaluation, in all cases, 6 roots were subjected to measurement (observed) and the resulting numerical value corresponded to the average value for such 6 roots.

Anthocyanin: the color was identified according to the DIC pocket type color chart. A case where the value of M in CMYK was less than 40 was rated as AA, and a case where the value of M in CMYK was 40 or more was rated as BB.

Physiological disorder: a case where the leaf of the resulting seedling had no problem was rated as AA, a case where any twist or spot was slightly observed on the leaf was rated as BB, and a case where any twist or spot was numerously observed on the leaf was rated as CC.

The stem length was defined as the length from the culture soil surface to the vicinity of the growth point. The stem diameter was measured by a digital caliper at the location immediately above the seed leaf.

The aerial part fresh weight and the aerial part dry weight were measured by an electronic force balance. The leaf was defined as the total of the leaf blade and the leaf stem, and the stem was defined as the remaining moiety obtained by removing the leaf from the shoot of the aerial part. After measurement of the fresh weight, the leaf and the stem of each moiety of each individual were each separately put into a paper bag, dried in an incubator at a temperature of 105° C. for 72 hours and thereafter cooled to room temperature, taken out from the incubator, and subjected to measurement of the dry weight.

The number of true leaves (designated as the number of leaves in Table 2) was defined as the number of true leaves having a length of 1 cm or more, and was visually determined.

The ratio stem length/dry weight was calculated, as the index of spindly growth, by dividing the stem length by the aerial part dry weight value. The number of floral buds having a diameter of 1 mm or more were counted through visual observation.

TABLE 1
Conditions of seedling growth by artificial light irradiation

| | | | | Proportion | | | | | |
|---|---|---|---|---|---|---|---|---|---|
| | | | | of | | | | | |
| | | | | period | | Length | | | |
| | | Intensity of blue | Intensity of red | (A-1) to | Period | of dark | | Cultivation | |
| | Light | irradiation light | irradiation light | period (A) | (C) | period | Temperature | period | |
| | condition | (μmol · m⁻² · s⁻¹) | (μmol · m⁻² · s⁻¹) | (time ratio) | (hours) | (hours) | and humidity | (days) | Breed |
| Example 1 | B/RB + D | 145 | 290 | 50% | — | 4 | Condition A | 18 | CF |
| Example 2 | B/RB + D | 145 | 290 | 50% | — | 4 | Condition A | 18 | MOMO |
| Example 3 | B/RB + D | 145 | 290 | 50% | — | 4 | Condition B | 21 | MOMO |
| Example 4 | B/RB + D | 80 | 290 | 50% | — | 4 | Condition B | 21 | MOMO |
| Example 5 | B/RB + R + D | 145 | 290 | 33% | 5 | 4 | Condition B | 18 | MOMO |
| Comparative | FL | — | — | — | — | 8 | Condition A | 21 | CF |
| Example 1 | | | | | | | | | |
| Comparative | FL | — | — | — | — | 8 | Condition A | 18 | MOMO |
| Example 2 | | | | | | | | | |
| Comparative | FL | — | — | — | — | 8 | Condition B | 21 | MOMO |
| Example 3 | | | | | | | | | |
| Comparative | RB + D | 90 | 178 | 100% | — | 8 | Condition B | 21 | MOMO |
| Example 4 | | | | | | | | | |
| Example 6 | B/RB + D | 145 | 485 | 30% | — | 4 | Condition B | 21 | CF |
| Example 7 | B/RB + D | 145 | 290 | 50% | — | 4 | Condition B | 21 | CF |
| Example 8 | B/RB + D | 161 | 322 | 50% | — | 6 | Condition B | 21 | CF |
| Comparative | B/RB + D | 145 | 182 | 80% | — | 4 | Condition B | 21 | CF |
| Example 5 | | | | | | | | | |
| Example 9 | B/RB + D | 145 | 224 | 65% | — | 4 | Condition A | 21 | MOMO |
| Comparative | FL | — | — | — | — | 2 | Condition A | 21 | MOMO |
| Example 6 | | | | | | | | | |

TABLE 2
Results of seedling growth by artificial light irradiation

| | Aerial | Aerial | | | | | | | |
|---|---|---|---|---|---|---|---|---|---|
| | part | part | | Stem | | Number | Number | | |
| | fresh | dry | Stem | length/dry | Stem | of | of floral | | |
| | weight | weight | length | weight | diameter | leaves | buds (visual | | Physiological |
| | (g) | (g) | (cm) | (mm · mg⁻¹) | (mm) | (leaves) | observation) | Anthocyanin | disorder |
| Example 1 | 12.6 | 1.59 | 18.0 | 0.12 | 6.9 | 7.0 | 1.5 | AA | AA |
| Example 2 | ND | 1.02 | 15.4 | 0.15 | 6.2 | 6.8 | 0 | AA | AA |
| Example 3 | 4.1 | 0.65 | 9.3 | 0.14 | 4.3 | 5.3 | 0 | AA | AA |
| Example 4 | 7.6 | 0.86 | 18.5 | 0.22 | 5.2 | 6.8 | 0 | AA | AA |
| Example 5 | 5.0 | 0.57 | 11.5 | 0.21 | 4.9 | 5.7 | 0 | AA | AA |
| Comparative | 11.4 | 1.19 | 14.3 | 0.12 | 6.2 | 7.2 | 1.2 | BB | AA |
| Example 1 | | | | | | | | | |
| Comparative | ND | 0.61 | 13.2 | 0.22 | 5.3 | 6.2 | 0 | BB | AA |
| Example 2 | | | | | | | | | |
| Comparative | 4.1 | 0.66 | 9.1 | 0.14 | 4.4 | 5.2 | 0 | BB | AA |
| Example 3 | | | | | | | | | |
| Comparative | 3.2 | 0.48 | 7.6 | 0.16 | 3.7 | 5.8 | 0 | BB | BB |
| Example 4 | | | | | | | | | |
| Example 6 | 7.4 | 0.64 | 17.0 | 0.27 | 5.3 | 7.0 | 0 | AA | AA |
| Example 7 | 7.8 | 0.70 | 17.9 | 0.26 | 5.4 | 7.2 | 0 | AA | AA |
| Example 8 | 7.9 | 0.70 | 20.6 | 0.29 | 5.1 | 7.2 | 0 | AA | AA |
| Comparative | 6.7 | 0.69 | 10.1 | 0.15 | 5.6 | 7.0 | 0 | BB | AA |
| Example 5 | | | | | | | | | |
| Example 9 | 10.5 | ND | 18.4 | ND | 5.6 | 7.7 | ND | AA | AA |
| Comparative | 11.3 | ND | 18.1 | ND | 5.8 | 8.1 | ND | BB | BB |
| Example 6 | | | | | | | | | |

TABLE 3
Growth on day 30 of settling

| | Number of flowers (flowers) | | | Number of fruits (fruits) | | |
|---|---|---|---|---|---|---|
| | First flower | Second flower | Third flower | First flower | Second flower | |
| | cluster | cluster | cluster | cluster | cluster | SPAD value |
| Example 3 | 4.00 | 5.17 | 4.67 | 0.83 | 1.83 | 44.2 |
| Comparative | 3.17 | 6.17 | 5.67 | 0.33 | 1.33 | 40.0 |
| Example 3 | | | | | | |

It can be seen from Tables 1 and 2 that a plant seedling obtained by the cultivation method of the present invention has a green leaf small in the amount of anthocyanin. A plant seedling obtained by the present invention can be suppressed in spindly growth, and can be stably planted.

It can be seen from Table 3 that, when a plant seedling obtained by the cultivation method of the present invention is planted, the plant seedling has a larger number of fruits and a higher SPAD value than conventional one. That is, growth after planting is also favorable.

1. A method for cultivating a plant seedling by irradiation of the plant seedling with artificial light for promotion of growth, the method comprising
continuously irradiating the plant seedling with blue illumination light for period (A), wherein 30% or more and less than 80% of a time taken for period (A) for continuously irradiating the plant seedling with blue illumination light corresponds to period (A-1) for continuously irradiating the plant seedling with blue illumination light and red illumination light.

2. The method for cultivating a plant seedling according to claim 1, wherein a time taken for one period (A-1) for continuously irradiating the plant seedling with blue illumination light and red illumination light is 1 to 20 hours.

3. The method for cultivating a plant seedling according to claim 1, comprising not irradiating the plant seedling with any light for period (B).

4. The method for cultivating a plant seedling according to claim 3, wherein a time taken for one period (B) for not irradiating the plant seedling with any light is 1 to 12 hours.

5. The method for cultivating a plant seedling according to claim 3, wherein a time taken for period (B) for not irradiating the plant seedling with any light is 4 to 50% relative to 100% of the time taken for period (A) for continuously irradiating the plant seedling with blue illumination light.

6. The method for cultivating a plant seedling according to claim 3, wherein continuously irradiating the plant seedling with blue illumination light for period (A) and not irradiating the plant seedling with any light for period (B) are alternately repeated.

7. The method for cultivating a plant seedling according to claim 3, comprising continuously irradiating the plant seedling with only red illumination light for period (C) between period (A) for continuously irradiating the plant seedling with blue illumination light and period (B) for not irradiating the plant seedling with any light wherein a time taken for period (C) is more than 0 hours and 5 hours or less.

8. The method for cultivating a plant seedling according to claim 3, not comprising continuously irradiating the plant seedling with only red illumination light for period (C).

9. The method for cultivating a plant seedling according to claim 3, wherein the time taken for one period (A) for continuously irradiating the plant seedling with blue illumination light is 2 to 24 hours.

10. The method for cultivating a plant seedling according to claim 1, wherein the blue illumination light has a wavelength range from 400 to 515 nm and a center wavelength of 430 to 470 nm.

11. The method for cultivating a plant seedling according to claim 1, wherein the red illumination light has a wavelength range from 570 to 730 nm and a center wavelength of 640 to 680 nm.

12. The method for cultivating a plant seedling according to claim 1, wherein an amount of the blue illumination light is 40 to 200 μmol/(m² s) in terms of a photosynthetic photon flux density on a plant cultivation surface.

13. The method for cultivating a plant seedling according to claim 1, wherein an amount of the red illumination light is 40 to 500 μmol/(m² s) in terms of a photosynthetic photon flux density on a plant cultivation surface.

14. The method for cultivating a plant seedling according to claim 1, wherein, during period (A-1) for continuously irradiating the plant seedling with blue illumination light and red illumination light, a photosynthetic photon flux density of the red illumination light is 100 to 1000% relative to a photosynthetic photon flux density of the blue irradiation light on a plant cultivation surface.

15. The method for cultivating a plant seedling according to claim 1, wherein a relative humidity in cultivation is 39 to 90%.

16. The method for cultivating a plant seedling according to claim 1, wherein a temperature in cultivation is 16 to 28° C.

17. The method for cultivating a plant seedling according to claim 1, wherein the plant seedling is a fruit vegetable seedling.

18. The method for cultivating a plant seedling according to claim 1, wherein the plant seedling is a nightshade plant seedling.

19. The method for cultivating a plant seedling according to claim 1, wherein the plant seedling is a tomato seedling.

20. A method for cultivating a plant, comprising planting in a farm field a plant seedling cultivated by the method for cultivating a plant seedling according to claim 1 and cultivating the plant seedling by natural light.
